(19) United States
(12) Patent Application Publication
(10) Pub. No.: US 2003/0052864 A1
(43) Pub. Date: Mar. 20, 2003

(54) Method and device for processing and displaying coded data stored in a smart card

(76) Inventors: Thierry Sert, Chateauneuf-le-Rouge (FR); Pierre-Philippe Cormeraie, Eguilles (FR)

Correspondence Address: BANNER & WITCOFF, 1001 G STREET N W, SUITE 1100, WASHINGTON, DC, 20001, US

(21) Appl. No.: 09/936,944

(22) PCT Filed: Jan. 19, 2001
(86) PCT No.: PCT/FR01/00194

(30) Foreign Application Priority Data
Jan. 19, 2001 (FR) 00/00684

(51) Int. Cl. G09G 5/00

(52) U.S. Cl. 345/173

(57) ABSTRACT

The invention concerns a device (1) and a method for processing information derived from coded data stored in a smart card (2), corresponding to operations associated with at least a user-loyalty developing program aimed at a tradesman. The device comprises reading means (3), read/write storage means (5, 6), computing means (6, 7) and data display means (8, 9) The smart card memory comprises several data registers (15) respectively assigned to several different tradesmen and/or corresponding to several loyalty developing programs, comprising files concerning the behavior of the card bearer with the tradesman/tradesmen concerned. The computing means (6, 7, 8) include means for homogeneously formatting the data derived from the registers, the display means (8,9) being designed to display the data homogeneously as well. Means (10) are also provided for a user of the device to browse through the stored data to obtain display of the data

The present invention relates to a device for processing and displaying information obtained from coded data stored in a smart card, corresponding to operations associated with at least one program for keeping a user loyal to at least one trader, of the type comprising means for reading coded data from the memory of the smart card, storage means with reading/writing of the data, calculating means and data-display means.

It also relates to a method employing such a device.

It finds a particularly important although not exclusive application in the field of the verification of the content of the data stored in smart cards, especially of loyalty cards or of banker's cards, which are presented at the moment of payment by a holder of the card to a trader, for example a shop or supermarket, to a service station, or to a motor-car dealership, in order to obtain advantages which are defined as a function of the recency, of the frequency, or of the amount of the purchase made by the user of the card.

Apparatus is already known which makes it possible to display the number of points contained in a loyalty card on a smart card, or even on a payment terminal or an electronic key ring.

However, such apparatus exhibits drawbacks.

It does not allow the consumer, the user of the card, to read the coded information freely on different types of card.

Neither does it offer the user a clear, comprehensible and immediate view of the accumulated points and advantages present on the card, for each of the programs and/or the traders concerned.

In other words, with such apparatus, it is not possible to obtain and to display in real time all the information present on different types of cards used by different traders.

The user is therefore obliged to remember his position for each of the programs, and/or to keep the till receipts issued during the transactions, which necessarily entails errors and omissions.

The present invention aims to provide a device and a method responding better than those known hitherto to the requirements of actual practice, especially in that it makes it possible to read from a smart card and to display in real time, and in a uniform graphics form, on the one hand the contents of the various electronic loyalty programs issued by several traders, and, on the other hand, the position, at a given date, of the carrier of the smart card for each of these different programs.

With the invention, the consumer has access to the information with a user-friendly display system which is simple to understand, based, for example, on a scale, with graduations, a unit of measurement and an associated qualitative state.

Furthermore, a single hardware device is required to gain access in real time to all the information stored on several different types of cards, relating to different loyalty programs.

The consumer no longer has to remember his position in each program or else to store paper tickets. As to the trader, he inherits all the advantages of the known systems of the prior art, while increasing his chances of keeping the consumer loyal.

To that end, the invention especially proposes a device for processing and displaying information obtained from coded data stored in a smart card, corresponding to operations associated with at least one program for keeping a user loyal to at least one trader, the device comprising means for reading coded data from the memory of the smart card, storage means with reading/writing of data, calculating means and data-display means, characterized in that, with the memory of the smart card including several data registers respectively allocated to several different traders and/or corresponding to several loyalty programs, said registers comprising files, called Behavior files, relating to the behavior of the holder of the card with the trader or traders concerned, the calculating means include means for formatting data output from the registers in a uniform way, the display means being configured to display, also in a uniform way, said information corresponding to said data thus formatted, and in that it further includes means for navigation through the stored data by a user of the device in order to obtain the display of said information.

Navigation means should be understood as meaning any touch or vocal means, for example a keyboard, a touch screen, a speech-recognition system, an infra-red remote control, etc.

In advantageous embodiments, recourse is had, moreover, to one and/or other of the following arrangements:

the means for formatting the data and for displaying the coded information in a uniform way comprise means for displaying a graduated scale;

the means for displaying a graduated scale include means for calculating and interpreting data stored in the card so as to update them dynamically as a function of the data corresponding to at least one loyalty program, said calculating means being configured to:

calculate for said program the number of intervals corresponding to the scale as a function or a predetermined unit of measurement of said program,

calculate the constant size of each interval,

display the end points of said scale and a state, called qualitative state, associated beforehand with said scale,

calculate the distance between two graduations of the scale corresponding to an interval,

calculate the level of the scale as a function of the data from the behavior files,

and display said scale level.

the navigation means comprise a touch screen;

the device is a portable telephone;

the device is a satellite decoder;

the device is a personal digital assistant, for example of the type sold by the American company US Robotics known by the name of Palm Pilot;

the device includes:

means for inputting the data of the coded information stored in the smart card into an intermediate storage memory and for displaying information obtained from said data,

means for storing coded data corresponding to one or more programs for keeping a user loyal to several traders,

means for comparison between the data input into said intermediate memory and data stored in said information-storage means, and

means for processing the results of these comparisons in order to display updated information.

The invention also proposes a method for employing the device described above.

The invention will be better understood on reading the description which follows of embodiments given by way of nonlimiting example. The description makes reference to the drawings which accompany it, in which:

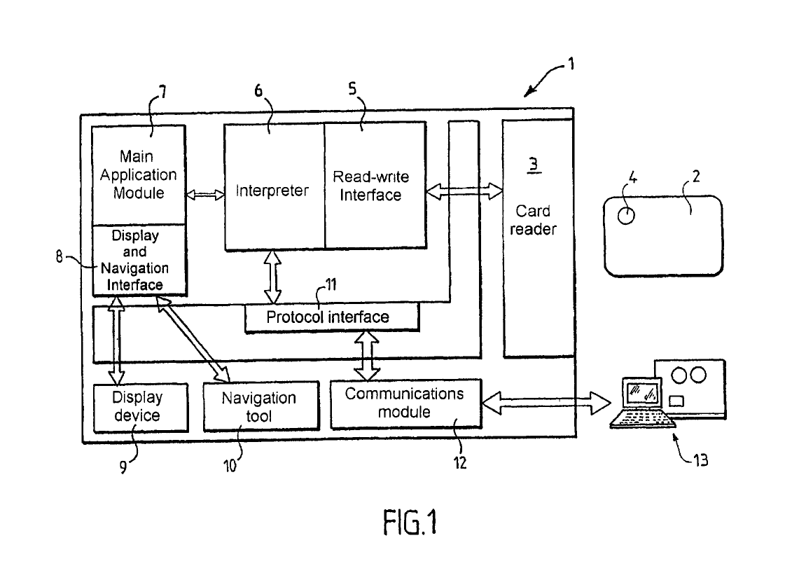

FIG. 1 shows an overall diagram of a device according to one embodiment of the invention.

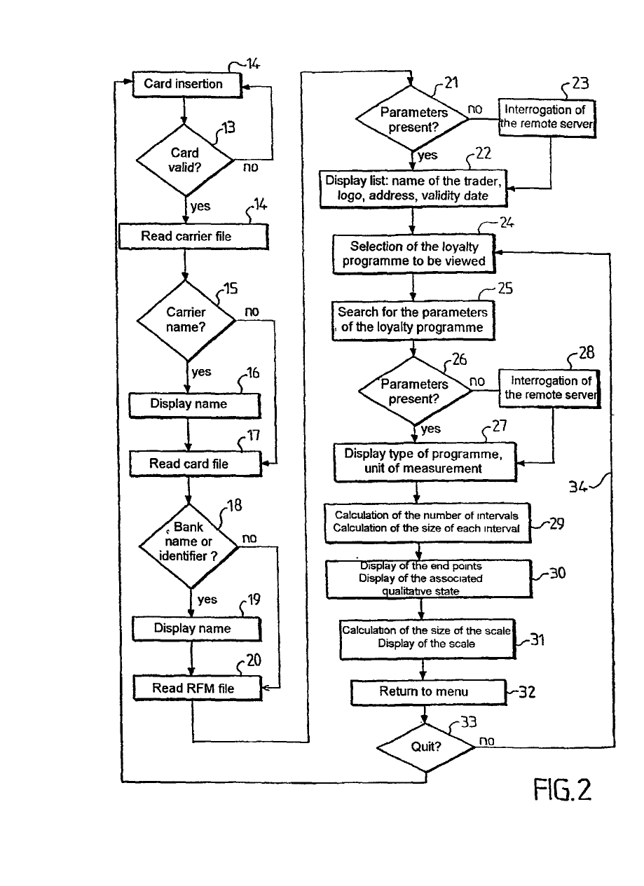

FIG. 2 is a general flowchart showing one embodiment of the processing method according to the invention.

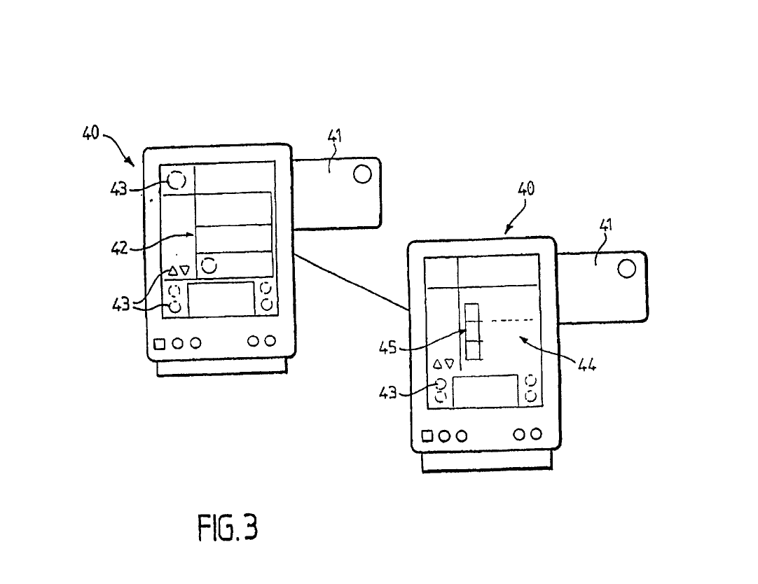

FIG. 3 shows an example application of a device according to one embodiment of the invention with a touch screen.

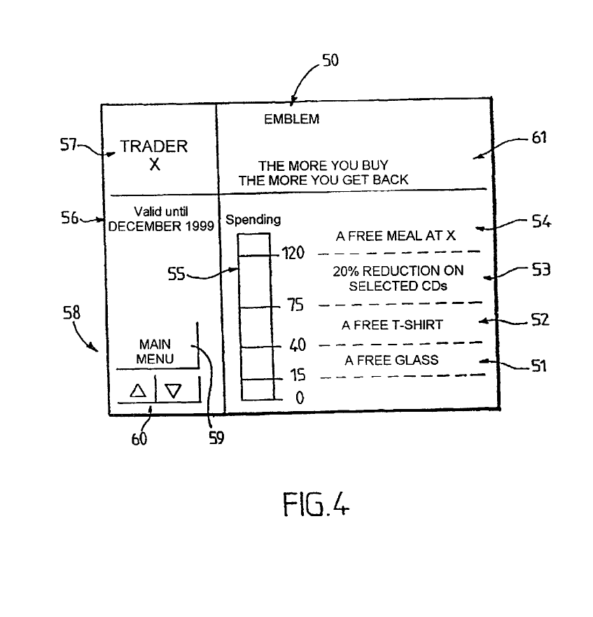

FIG. 4 is an example screen showing the display of a scale with the device of FIG. 3.

FIG. 1 shows a diagram of a device 1 allowing the carrier of a multi-application card 2 to view, in a uniform way, the content of different loyalty programs.

A loyalty program is a program containing rules for issuing, the types of bonuses and the messages associated with promotional programs, which is stored on an electronic card or in an electronic-points counter.

It employs loyalty mechanisms, such as the calculation of the recency of the visits, of the frequency of visits or of the amount of the purchases made by a consumer, for example, or a combination of these mechanisms.

The multi-application card 2 is of smart-card type, manufactured, for example, by the French company Schlumberger.

The hardware device 1 is, for example, an enhanced portable telephone, a satellite decoder with a card reader, a personal digital assistant or “organizer”. That may also be a payment terminal, a personal computer with a card reader, an electronic kiosk, an interactive terminal such as a ticket dispenser, etc.

The essential thing is that it can be programmable in order to carry out the functions of storage of information and of display of data stored on the card of the user.

The device comprises a set of software modules carrying out the functions of reading and interpreting the data corresponding to loyalty information contained in the card and for distributing information interpreted for viewing, in a uniform way, incorporating a scale, graduations, a unit of measurement and an associated qualitative state.

More precisely, the device 1 comprises means 3 for reading the card 2 with a chip 4 which are connected to a read/write interface circuit 5 which is in itself known, interpreter means 6, converting the data read by the reader into a uniform presentation which will then be processed by a main application module 7 interfaced with a navigation and display interface module 8.

The interpreter means 6, and the modules 7 and 8, are configured to allow presentation and displaying, graphically in a uniform way, and in an identical way as far as navigation by the user in the various programs and for the various traders is concerned. These means are, for example, microprocessors programd by an algorithm described in more detail by reference to FIG. 2.

The module 8 is connected to the display means 9, for example an LCD screen, which may be a touch screen, the navigation means 10 then being incorporated into the display means.

Tn the embodiment more particularly described here, the device 1 is configured to communicate updated information, via a protocol interface 11 and a communications module 12 (modem) with a server 13, situated remotely, (of PC or microcomputer, etc. type) and equipped with the necessary software.

It is known that the loyalty programs are different as regards the objectives to be achieved, a chain of restaurants not having the same objectives or the same constraints as a chain of supermarkets, as a furniture retailer or as a network of cinemas.

Likewise, the loyalty techniques used to meet these objectives are different.

They may be based on an accumulation of loyalty points, on a count of the number of visits, on an accumutation of proofs of purchase, etc.

Equally, the mechanism used will be different. For example, the acquisition of loyalty advantages may be based on fixed or proportional rules such as the frequency of visits, the amount of purchases, the recency between two visits, or a combination of several of these factors.

Finally the rules for issuing and for the content of the programs will vary infinitely, such as, for example:

“1 point for 10 FF spent”,

“A bonus of 20 points as from 200 FF of purchases”,

“Offer of a meal for 450 FF of purchases”

“Offer of a meal for 450 FF spent during the month”,

“Offer of a coffee if you come back within 10 days”,

“10% reduction on all the purchases you have made during your last 10 visits”.

The organization of the data files and the methods making it possible to carry out processing and display in a uniform way according to the invention will now be described.

Description of the Files Contained on the Card:

In the embodiment more particularly described here, and in such a way as to allow this processing and this display in a uniform way, the information contained in the card is distributed into 4 different tiles:

the Card file: this contains the information for describing the card, and especially:

the number of the card,

the name of the card (or an identifier making it possible to recover it),

the expiry date,

the Carrier file: this groups together information describing the carrier of the card, such as:

the name of the carrier,

a number for identifying the carrier (such as a bank identification number),

demographic information, such as the date of birth, his address, etc.,

biometric information, such as the height of the carrier, etc.

the Points file: this stores the accumulated total of loyalty points acquired by the card carrier with one or more traders,

the RFM file: this stores the history of the purchasing behavior for each of the traders frequented by the card carrier. It is structured into records, each record containing the information specific to the loyalty program(s) of a trader (or of several when the loyalty program is common to several traders).

Each record contains:

a number for identifying the loyalty program,

the type of loyalty program run by this trader,

the date of expiry of the loyalty program,

the date of the last visit made to this trader,

the number of visits made to this trader,

the accumulated amount of the purchases made from this trader.

FIG. 2 shows a general processing flowchart for the uniform formatting of the information, its uniform display and easy navigation by a user allowing him to obtain the information sought.

At 14, the user inserts a smart card 2 into the device 1, the validity of which is tested at 13.

If the card is valid, the detector device reads the carrier file (stage 14), searches at 15 for the name of the carrier, displays it at 16, then reads the card file (stage 17). If no carrier name is found, the test 15 makes it possible to access stage 17 directly.

Next, the existence of a bank identifier or name is tested at 18. If it is found, the name of the bank is displayed at 19.

The reading of the RFM file is then carried out (stage 20) either via the display stage 19, or directly in the case in which no bank is identified following the test 18.

If the parameters sought are present (stage 21), the LCD screen displays the list at 22, namely and especially the name of the trader, his logo, his address, the validity date, etc.

In the event that the parameters sought are not present, an interrogation (stage 23) of a server entirely situated remotely is, for example and if appropriate, carried out.

Once the display has been produced, the loyalty program to be viewed is selected (stage 24).

This selection stage is followed by a stage (25) for searching for the parameters of the loyalty program.

If these parameters are present or identified (test 26), there is a display (stage 27, see below) of the type of program and of the units of measurement allowing the uniform presentation of these parameters.

Display of Loyalty Program (Stage 27)

Display scale and indicate the unit of measurement of the program (# of visits or accumulated amount of purchases);

place the explicit graduation marks on the scale, according to their values;

beside each graduation mark, place the legend corresponding to the qualitative state associated with the graduation mark;

fill in the scale according to the # of visits or accumulated amount recorded in the card of the carrier.

If the parameters are not present, an interrogation, at 28, of a remote server is, for example and if appropriate, carried out.

The display of the program is then followed by a stage 29 of calculation of the number of intervals and of the size of each of these intervals, then of a display at 30 of the end points and of the associated qualitative state.

Then a calculation of the size of the scale and its display according to the invention are carried out at 31.

The return to the menu (stage 32) before a test 33 in order to continue the visual display is then carried out.

If the user decides not to quit, he then comes back (link 34) to the stage 24 of selection of the loyalty program described above.

The content of the stages of the embodiment of the invention more particularly described here will now be detailed, showing the algorithm for updating and displaying the information in a dynamic way.

A. Search for and Display of the General Information (Stages 14 to 19):

reading of the carrier file from the card: name of the carrier

reading of the card file: name (or identifier of the bank

date and time, etc.

B. Search by Reading of the RFM File of the Card or of the Loyalty Programs Present in the Card (Stages 20 to 23):

The RFM file is structured into records which contain the information specific to each loyalty program present in said RFM file of the card of the carrier. Each record is characterized by an identification number.

For each of the programs identified:

1. Search for the general information of the loyalty program (interrogation of the remote server, if necessary):

name of the chain

address

date of validity of the program

graphical logo of the trader, etc.

2. Display of the list of the loyalty programs and of the general information specific to each of them.

C. Selection of a Program and Display (Stages 24 to 31)

1. Search for the parameters of the loyalty program (interrogation of the remote server if necessary):

type of the program (frequency, amount, points, etc.)

units of measurement (number of visits, FF, number of points, etc.)

number of scenarios

end points of each of these scenarios

qualitative state on each of the scenarios (example: wording of message or coupon) etc. giving, for example, a state of the type:

Graduation 1: value and qualitative state,

Graduation 2: value and qualitative state,

Graduation 3: value and qualitative state,

Graduation 4: value and qualitative state.

2. Display of the scale and of the parameters.

A representation in pseudocode is given below, for example, for a loyalty program based on the frequency of the visits:

let lower end point (i) be the value of the lower end point of the scenario (i)

let upper end point (i) be the value of the upper end point of the scenario (i)

associated qualitative state (i), the message relating to the implementation of the scenario (i)

graduation size (i), the size between two graduations over the interval corresponding to the scenario (i)

Calculation of the number of intervals:

Start

If lower end point (1) = 0
then number of intervals = number of scenarios
otherwise number of intervals = number of
scenarios + 1
Endif

End

Calculation of the constant size of each interval:

Size of each interval=total size/number of intervals

Display of the end points and of the associated qualitative state (two cases depending on whether the first lower end point is equal to zero or not):

Start

If lower end point (1) = 0
Then

for i = 1 to number of scenarios
display lower end point of scenarios (i)
display associated qualitative state (i)
End for

Otherwise

lower end point of scenario (0) = 0
associated qualitative state (0) = empty
for i = 0 to number of scenarios
display qualitative state of scenarios
(i)
display associated qualitative state (i)
end for

Endif

End

Calculation of the size between two graduations over each interval:

Start
If lower end point (1) = 0
Then

lower end point (number of scenarios + 1) =
upper end point (number of scenarios)
for i = ⊥ to number of scenarios

graduation size (i) = size of each interval /
(lower end point (i + 1) −
lower end point (i))
end for

Otherwise

lower end point (0) = 0
lower end point (number of scenarios +
1) = upper end point (number of scenarios
for i = 0 to number of scenarios

graduation size (i) = size of each
interval / (lower end point (i + 1) −
lower end point (i))

end for

Endif

End

Calculation of the size and display of the scale:

Let No. Visits be the value of the number of visits stored in the card

Start

1 = 1
level = graduation size (i)
while i is less than “No. Visits”

level = level + size (i + 1)
⊥ = i + 1
End while
Display level

End

The description of the parameters contained in the terminal is, moreover, as follows, for example.

Campaign parameters:

identification number of the loyalty program

name of the loyalty program

validity of the program: daily, weekly, monthly, bounded (from date to date), annual, infinite

type of program: frequency, amount, recency

frequency accepted: all the visits are taken into account or one visit per day only

rules for issuing the advantages, presented in the form of bonus scenarios including: minimum and maximum end points for activating the scenario, loyalty bonuses.

Advantageously, the graduated scale includes an associated qualitative state updated dynamically, resulting from a calculation and from an interpretation of the information contained on the card compared with the descriptive information on the loyalty program of the trader, the calculating rules playing a part in the construction of the scale being:

1. Calculation of the number of intervals

2. Calculation of the constant size of each interval

3. Display of the end points and of the associated qualitative state

4. Calculation of the size between two graduations on each interval

5. Calculation of the size and display of the level of the scale.

In FIG. 3 is then represented an example device with a card according to the invention.

This takes the form of an “organizer” device 40 of the type sold under the trademark “Palm Pilot” by the American company US ROBOTICS with a liquid-crystal screen.

The smart card 41 is inserted, for example, on its side, into the card reader of the device, a navigation LCD screen 42 being displayed and making it possible, after interrogation by touch keys 43 on the LCD screen, to make the screen 44 appear with the scale 45.

An example of a display system will now be described with reference to FIG. 4.

The objective to be achieved here is to increase the amount of the purchases in the emblem 50. To do this, the loyalty technique used is the counting of the number of visits.

The mechanism used, for its part, is the acquisition of loyalty advantages based on proportional rules relating to the amount of the purchases made up to a cut-off date.

The rules for issuing and the content of the program are, for example:

an offer of a drink as from 15 FF of purchases, (line 51)

an offer of a T-shirt as from 40 FF of purchases, (line 52)

20% off a selection of discs as from 75 FF of purchases (line 53)

an offer of a meal at the restaurant of the shop as from 120 FF of purchases, (line 54).

A scale 55 makes it possible to view the thresholds corresponding to the advantages directly.

Information 56 on the validity, on the name of the trader 57 and on the navigation means 58 (return to the main menu 59 and/or move on 60 to the other traders or programs) are provided here directly on the screen 61, which is a touch screen.

Other objectives can be sought, such as increasing the frequency of monthly visits and/or the average shopping basket, for example.

The operation of the invention will now be described n the context of a particular example, by reference to FIG. 1.

When a card carrier 2 wants to get to know the contents of his smart card, it is sufficient for him to insert it into the card reader incorporated in or connected to the device 1.

At that moment, the Interpreter means 6 access the information contained in the card 2, by way of the Read/Write Interface circuit 5.

When the information contained in the card is comprehensive, the Interpreter means 6 distribute these data to the Main Application Module 7.

When the information contained in the card is partial, the Interpreter means 6 obtain the missing information by means of a remote interrogation of the Information Server 20 by way of the Communications Module 13 and of the Protocol Interface 11.

The Interpreter means 6 then compare the Information from the card with that originating from the Server, then distribute it to the Main Application Module.

After receiving these data, the Main Application Module 7 formats them and transmits them to the display means 10 for viewing. These data can then be consulted by the carrier by means of the Navigation means or the Tool 10.

It goes without saying, and it also results from the foregoing, that the present invention is not limited to the embodiments more particularly described. On the contrary, it embraces all the variants.

1. A device (1) for processing and displaying information obtained from coded data stored in a smart card (2), corresponding to operations associated with at least one program for keeping a user loyal to at least one trader, the device comprising means (3) for reading coded data from the memory of the smart card, storage means (5, 6) with reading/writing of data, calculating means (6, 7) and data-display means (8, 9), characterized in that, with the memory of the smart card including several data registers (5) respectively allocated to several different traders and/or corresponding to several loyalty programs, said registers comprising files, called Behavior files, relating to the behavior of the holder of the card with the trader or traders concerned, the calculating means (6, 7, 8) include means for formatting data output from the registers in a uniform way, the display means (8, 9) being configured to display, also in a uniform way, said information corresponding to said data thus formatted, and in that it further includes means (10) for navigation through the stored data by a user of the device in order to obtain the display of said information.

2. The device as claimed in claim 1, characterized in that the means (6, 7, 8) for formatting the data and for displaying (9) the coded information in a uniform way comprise means for displaying a graduated scale.

3. The device as claimed in claim 2, characterized in that the means for displaying a graduated scale include means for calculating and interpreting data stored in the card so as to update them dynamically as a function of the data corresponding to at least one loyalty program, said calculating means being configured to:
calculate for said program the number of intervals corresponding to the scale as a function of a predetermined unit of measurement of said program,
calculate the constant size of each interval,
display the end points of said scale and a state, called qualitative state, associated beforehand with said scale,
calculate the distance between two graduations of the scale corresponding to an interval,
calculate the level of the scale as a function of the data from the behavior files,
and display said scale level.

4. The device as claimed in any one of the preceding claims, characterized in that the navigation means comprise a touch screen (42).

5. The device as claimed in any one of the preceding claims, characterized in that it includes the elements of a portable telephone.

6. The device as claimed in any one of claims 1 to 4, characterized in that it includes the elements of a satellite decoder.

7. The device as claimed in any one of claims 1 to 4, characterized in that it includes the elements of a personal digital assistant.

8. The device as claimed in any one of the preceding claims, characterized in that it includes:
means (3) for inputting the coded data stored in the smart card into an intermediate storage memory and for displaying this information obtained from said data,
means for storing coded data corresponding to one or more programs for keeping a user loyal to several traders,
means for comparison between the data input into said intermediate memory and data stored in said information-storage means, and
means for processing the results of these comparisons in order to display updated information.

9. A method for processing and displaying information obtained from coded data stored in a smart card, corresponding to operations associated with at least one program for keeping a user loyal to at least one trader, in which the coded data are read (14, 17, 20) from the memory of the smart card, and they are stored in a memory with reading/writing of data, characterized in that, with the memory of the smart card including several registers respectively allocated to several different traders and/or corresponding to several loyalty programs, said registers comprising files, called Behavior files, relating to the behavior of the holder of the card with the trader or traders concerned, an algorithmic processing is carried out (29, 30, 31) in order to format information output from the registers in a uniform way, and said information thus formatted is displayed (30, 31) also in a uniform way.

10. The method as claimed in claim 9, characterized in that the stored data are navigated through in order to obtain the display of the information corresponding to the trader and/or to the loyalty program sought.

11. Ther method as claimed in claim 10, characterized in that the coded information is displayed in the form of a graduated scale.

12. The method as claimed in claim 11, characterized in that the information obtained from the coded data is updated dynamically as a function of the data corresponding to at least one loyalty program, said update comprising the following stages:
for said program, the number of intervals corresponding to the scale is calculated (29) as a function of a predetermined unit of measurement of the loyalty program,
the constant size of each interval is calculated (29),
the end points of said scale and a state, called qualitative state, associated beforehand with said scale are displayed (30),
the distance between two graduations of the scale corresponding to an interval is calculated (31),
the level of the scale is calculated (31) as a function of the data from the behavior file,
and said scale level is displayed (31).

13. The method as claimed in any one of claims 9 to 12, characterized in that:
coded data stored in the smart card are input into a memory for intermediate storage and for display of the information obtained from said data,
said given information is compared with the coded data corresponding to one or more programs for keeping a user loyal to several traders,
and the results of these comparisons are processed in order to display updated information.
